(19) United States
(12) Patent Application Publication
(10) Pub. No.: US 2010/0058387 A1
(43) Pub. Date: Mar. 4, 2010

(54) METHOD FOR UPDATING STRUCTURED DATA BROADCAST IN LOOP TO MOBILE TERMINALS

(75) Inventors: Philippe De Cuetos, Paris (FR); Gwénaël Durand, Paris (FR); Cédric Thienot, Paris (FR); Eric Brechemier, Fontainebleau (FR)

Correspondence Address: SEED INTELLECTUAL PROPERTY LAW GROUP PLLC, 701 FIFTH AVE, SUITE 5400, SEATTLE, WA, 98104, US

(73) Assignee: EXPWAY, Reims (FR)

(21) Appl. No.: 12/549,267

(22) Filed: Aug. 27, 2009

Related U.S. Application Data
(63) Continuation-in-part of application No. PCT/IB2008/000466, filed on Feb. 14, 2008.

(30) Foreign Application Priority Data
Feb. 28, 2007 (FR) 0701442

(51) Int. Cl. H04N 5/445

(52) U.S. Cl. 725/39

(57) ABSTRACT

A method for the acquisition of structured data to be memorized by a terminal, the structured data being periodically broadcasted in the form of sets of structured data flows, the method comprising: receiving a starting data flow available at an address known by the terminal and comprising information for accessing at least one selected set of structured data flows, associated to an update piece of information, determining according to the update piece of information if the selected set has been updated, and if the selected set has been updated: receiving structured data flows of the selected set, and updating the data memorized by the terminal with the updated data received.

### BACKGROUND

1. Technical Field

The present disclosure relates to the broadcast of structured information to fixed or mobile terminals. The present disclosure more particularly but not exclusively relates to the broadcast of video program guides, for example in accordance with the ESG standard (Electronic Guide Service) in a system of the type IP Datacast (IPDC) for broadcasting video programs according to the DVB-H standard (Digital Video Broadcast—Handheld).

2. Description of the Related Art

The broadcast system IPDC, specified in the document ETSI 102 471, V1.1.1 (2006-04), “Digital Video Broadcasting (DVB); IP Datacast over DVB-H: Electronic Service Guide (ESG)”, makes it possible to supply digital contents and services using mechanisms based on the IP protocol (Internet Protocol), which are optimized for terminals having limited calculation and powering means. The system IPDC comprises a unidirectional broadcast path which may be combined with one or more bidirectional paths using a mobile or cellular network to supply interactive services.

The ESG standard offers a service of program guides allowing users to select services and programs. In reality, program guide information displayed by a terminal corresponds to a part of broadcasted information. That is the reason why program guide information is distributed among different data flows, available from different IP addresses.

Thus, the information required to display a program guide is transmitted in the form of structured data flow, called “ESG sessions”, which is transmitted in loop and available at determined IP addresses. The structured data, also called “metadata”, allow in particular information to be searched, a hard disc to be programmed, and a video program schedule to be displayed. Metadata are for example structured using a language for structuring information such as XML (extended Markup Language). Thus, display data flows may comprise information of different natures, such as text information, and images, which may require to be updated according to different update periods.

The IP addresses of data flows of a program guide are also transmitted in the form of an acquisition data flow called “Announcement Session”, which is available at a particular IP address. An acquisition data flow also supplies indexing data allowing a particular piece of information to be accessed in a display data flow. The IP addresses giving access to available program guides, i.e. to the acquisition data flows of the available program guides are also gathered into a starting data flow, called “Bootstrap Session”, which is available at an IP address known by mobile terminals.

Thus, the quantity of data necessary to receive and display a program guide on a terminal may be relatively significant for the terminal, given the size of its memory. The aforementioned structure of the data allowing a program guide to be displayed also proves to be complex and therefore requires a relatively high computing power of the terminal. The result is that if the processes are performed by a mobile terminal, they may not be performed at a high frequency, or the supply battery of the terminal may rapidly discharge.

The data flows are broadcasted in loop or carousel mode during repetitive cycles. Thus, all the information of a flow may be obtained by accessing the IP address of the flow, and by listening the data flow broadcasted during a broadcast cycle. The information of a program guide is distributed among the display data flows according to the frequency at which it must be repeated, each flow having its own cycle duration.

The process for updating a program guide on a terminal comprises four successive periods T1-T4 which are indefinitely repeated. During the period T1 which may be around 24 h, or less for example in the event of an extraordinary update, the terminal does not try to perform an update. At the end of the period T1, the terminal triggers an update operation spreading over the periods T2, T3 and T4. During the period T2, the terminal is connected to the network to obtain the program guide information. During the period T3, the terminal processes the information received and updates the program guide which it stores in its memory. The program guide in the memory of the terminal is then displayed during the period T4.

The periods T3 and T4 depend on the nature and quantity of data contained in the program guide, and on the characteristics of the terminal. The periods T3 and T4 are usually around several seconds or minutes.

The period T2 which may last several dozens of minutes proves to be relatively long and expensive in terms of electrical consumption. The period T2 proves to be all the more penalizing as the information which is obtained during this period usually comprises no update. The period T1 is therefore chosen relatively long to avoid update operations of a program guide on a terminal being repeated too often, and therefore to avoid the battery feeding the terminal discharging too quickly. The result is that it is not possible to perform updating the program guides memorized by the terminals, at a short frequency, or quickly after a change of program.

To guarantee the management of the program guide update, each set of information of a flow is associated to a version number and to an expiration date which are defined in the flow.

The expiration date of a data set of a flow does not mean that the corresponding information has necessarily been updated, but simply indicates to the terminals if the set of information associated to the expiration date is still valid or if they must ignore the set of information. The expiration date of a set of data also indicates to the terminals when they should access again the network to search for possible updates. Due to the duration length of the period T1, it is therefore usual that a terminal memorizes invalid data during a quite long period.

### BRIEF SUMMARY

An object of an embodiment of the present disclosure is therefore to allow a program guide memorized by a terminal to be updated more rapidly, and therefore the update frequency of a program guide memorized by the terminal to be increased, without significantly increasing the electrical consumption of the terminal.

This object is reached by the provision of a method for receiving structured data to be memorized by a terminal, the structured data being periodically broadcasted in the form of structured data flows, the method comprising:

(a) receiving a starting data flow available at an address known by the terminal and comprising information for accessing at least one set of at least one structured data flow,

(b) selecting a set of structured data flows to be memorized by the terminal,

(c) receiving each structured data flow of the selected set, available using the access information supplied in the starting flow, and

(d) updating the data memorized by the terminal if the structured data received have been updated in relation to structured data memorized by the terminal.

According to one embodiment, each set of structured data flows is associated in the starting data flow to an update piece of information making it possible to deduce if data of the set of structured data flows have been updated, the step (a) comprising determining if the selected set of structured data flows has been updated, according to the associated update piece of information, comprised in the starting flow, the steps (c) and (d) being executed only if the selected set of structured data flows has been updated.

According to one embodiment, the piece of information for updating a set of structured data flows comprised in the starting flow comprises a version number, the method comprising comparing the version number of the selected set of structured data flows, received in the starting flow, to a version number memorized by the terminal, and updating the version number memorized by the terminal with the version number received.

According to one embodiment, the information for accessing at least one set of structured data flows to be memorized by the terminal comprises at least one address for accessing an acquisition data flow, the acquisition data flow comprising the address of each structured data flow of the set of structured data flows to be memorized by the terminal, the method comprising receiving an acquisition data flow at a selected access address, supplied in the starting data flow, and accessing each structured data flow to be memorized by the terminal, using each address supplied in the acquisition flow.

According to one embodiment, each structured data flow is associated to an update piece of information comprised in the corresponding acquisition flow and making it possible to deduce if the structured data flow has been updated, the steps (c) and (d) being executed for a structured data flow only if the structured data flow has been updated.

According to one embodiment, the piece of information for updating a structured data flow comprised in the acquisition flow is a version number, the method comprising comparing the version number of each structured data flow of the selected set, to a version number of the structured data flow memorized by the terminal, and updating the version number of the structured data flow memorized by the terminal with the version number received.

According to one embodiment, each structured data flow is associated to a table describing the structure of the data comprised in the flow and comprising the update piece of information making it possible to deduce if the structured data flow has been updated, each table of structured data flow being inserted into the corresponding acquisition data flow.

According to one embodiment, at least one of the data flows comprises a table describing the structure of the flow, receiving the flow being performed by receiving in parallel the table and the data of the flow.

According to one embodiment, at least one of the data flows is separated into two data flows available at different addresses, comprising a first flow comprising a table describing a structure of data, and a second flow comprising data which structure is described in the table of the first flow, the first flow and the second flow being received in parallel by the terminal.

According to one embodiment, several structured data flows are received in parallel by the terminal.

According to one embodiment, the method comprises displaying by the terminal structured data updated with the structured data received.

According to one embodiment, the structured data are data for displaying program guides transmitted to a system for broadcasting video programs according to the DVB-H standard.

The disclosure also relates to a terminal for receiving structured information to be memorized, the structured data being periodically broadcasted in the form of structured data flows, the terminal being configured to execute the following steps:

(a) receiving a starting data flow available at an address known by the terminal and comprising information for accessing at least one set of at least one structured data flow,

(b) selecting a set of structured data flow to be memorized by the terminal,

(c) receiving each structured data flow of the selected set, available using the access information supplied in the starting flow, and

(d) updating the data memorized by the terminal if the structured data received have been updated in relation to structured data memorized by the terminal.

According to one embodiment, each set of structured data flows is associated in the starting data flow to an update piece of information making it possible to deduce if data of the set of structured data flows have been updated, the terminal being configured to determine if the selected set has been updated according to the associated update piece of information, received in the starting flow, and to execute the steps (c) and (d) only if the selected set of structured data flows has been updated.

According to one embodiment, the piece of information for updating a set of structured data flows comprised in the starting flow comprises a version number, the terminal being configured to compare the version number of the selected set of structured data flows, received in the starting flow, to a version number memorized, and to update the version number memorized with the version number received.

According to one embodiment, the information for accessing at least one set of structured data flows to be memorized by the terminal comprises at least one address for accessing an acquisition data flow, the acquisition data flow comprising the address of each structured data flow of the set of structured data flows to be memorized by the terminal, the terminal being configured to receive an acquisition data flow at a selected access address, supplied in the starting data flow, and to access each structured data flow to be memorized, using each address supplied in the acquisition flow.

According to one embodiment, each structured data flow is associated to an update piece of information comprised in the corresponding acquisition flow and making it possible to deduce if the structured data flow has been updated, the terminal being configured to execute the steps (c) and (d) for a structured data flow, only if the structured data flow has been updated.

According to one embodiment, the piece of information for updating a structured data flow comprised in the acquisition flow is a version number, the terminal being configured to compare the version number of each structured data flow of the selected set, to a version number of the structured data flow memorized by the terminal, and to update the version number of the structured data flow memorized by the terminal with the version number received.

According to one embodiment, each structured data flow is associated to a table describing the structure of the data comprised in the flow and comprising the update piece of information making it possible to deduce if the structured data flow has been updated, each table of structured data flow being inserted into the corresponding acquisition data flow.

According to one embodiment, at least one of the data flows comprises a table describing the structure of the flow, the terminal being configured to receive in parallel the table and the data of the flow.

According to one embodiment, at least one of the data flows is separated into two data flows available at different addresses, comprising a first flow comprising a table describing a structure of data, and a second flow comprising data which structure is described in the table of the first flow, the terminal being configured to receive in parallel the first flow and the second flow.

According to one embodiment, the terminal is configured to receive several structured data flows in parallel.

According to one embodiment, the terminal is configured to display the structured data updated with the structured data received.

According to one embodiment, the structured data flows comprise data for displaying program guides transmitted to a system for broadcasting video programs according to the DVB-H standard.

According to one embodiment, the terminal comprises a mobile telephony device.

The disclosure also relates to a method for emitting structured data to be memorized by terminals, the structured data being periodically broadcasted in the form of structured data flows, the method comprising:
emitting a starting data flow available at an address known by terminals and comprising information for accessing at least one set of at least one structured data flow, and
emitting each structured data flow of each set of structured data flows,

According to one embodiment, each set of structured data flows is associated in the starting data flow to an update piece of information making it possible to deduce if data of the set of structured data flows have been updated.

According to one embodiment, the piece of information for updating a set of structured data flows comprised in the starting flow comprises a version number.

According to one embodiment, the information for accessing at least one set of structured data flows to be memorized by the terminals comprises at least one address for accessing an acquisition data flow, the acquisition data flow comprising the address of each structured data flow of the set of structured data flows, the method comprising emitting at least one acquisition data flow at an access address comprised in the starting data flow.

According to one embodiment, each structured data flow is associated to an update piece of information comprised in the corresponding acquisition flow and making it possible to deduce if the structured data flow has been updated.

According to one embodiment, the piece of information for updating a structured data flow comprised in the acquisition flow is a version number.

According to one embodiment, each structured data flow is associated to a table describing the structure of the data comprised in the flow and comprising the update piece of information making it possible to deduce if the structured data flow has been updated, each table of structured data flow being inserted into the corresponding acquisition data flow.

According to one embodiment, at least one of the data flows is separated into a first flow comprising a table describing a structure of data, and a second flow comprising data which structure is described in the table of the first flow, the first flow and the second flow being emitted in parallel at different addresses.

According to one embodiment, several structured data flows are emitted in parallel at different addresses.

According to one embodiment, the structured data are data for displaying program guides transmitted to a system for broadcasting video programs according to the DVB-H standard.

The disclosure also relates to a transmitter of structured information to be memorized by terminals, the structured data being periodically broadcasted in the form of structured data flows, the transmitter being configured to execute the following steps:
emitting a starting data flow available at an address known by the terminals and comprising information for accessing at least one set of at least one structured data flow, and
emitting each structured data flow of each set of structured data.

According to one embodiment, each set of structured data flows is associated in the starting data flow to an update piece of information making it possible to deduce if data of the set of structured data flows have been updated.

According to one embodiment, the piece of information for updating a set of structured data flows comprised in the starting flow comprises a version number.

According to one embodiment, the information for accessing at least one set of structured data flows to be memorized by the terminals comprises at least one address for accessing an acquisition data flow, the acquisition data flow comprising the address of each structured data flow of the set of structured data flows, the transmitter being configured to emit at least one acquisition data flow at an access address supplied in the starting data flow.

According to one embodiment, each structured data flow is associated to an update piece of information comprised in the corresponding acquisition flow and making it possible to deduce if the structured data flow has been updated.

According to one embodiment, the piece of information for updating a structured data flow comprised in the acquisition flow is a version number.

According to one embodiment, each structured data flow is associated to a table describing the structure of the data comprised in the flow and comprising the update piece of information making it possible to deduce if the structured data flow has been updated, each table of structured data flow being inserted into the corresponding acquisition data flow.

According to one embodiment, at least one of the data flows is separated into a first flow comprising a table describing a structure of data, and a second flow comprising data which structure is described in the table of the first flow, the transmitter being configured to emit in parallel the first flow and the second flow at different addresses.

### BRIEF DESCRIPTION OF THE SEVERAL VIEWS OF THE DRAWINGS

These and other objects, advantages and features of embodiments of the present disclosure will be described below in further details in the following description of an embodiment, in relation with, but not limited to the appended figures wherein:

FIG. 1 shows in block form a system for broadcasting program guides in a system for broadcasting video programs,

FIG. 2 shows in block form the information structure of program guides, according to prior art,

FIG. 3 shows in the form of a flowchart a procedure for updating a program guide executed by a terminal, according to prior art,

FIG. 4 shows in the form of a flowchart a procedure for updating a program guide executed by a terminal, according to one embodiment,

FIG. 5 shows in the form of a flowchart a procedure for updating a program guide executed by a terminal, according to another embodiment,

FIG. 6 shows in block form an information structure of program guide according to another embodiment,

FIGS. 7 and 8 show in the form of flowcharts procedures for updating a program guide executed by a terminal, according to two other embodiments,

FIG. 9 shows in block form an information structure of program guide according to another embodiment,

FIG. 10 shows in block form an embodiment of a device configured to receive information broadcast in repetitive cycles.

FIG. 11 shows in block form an embodiment of a transmitter configured to broadcast information in repetitive cycles.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

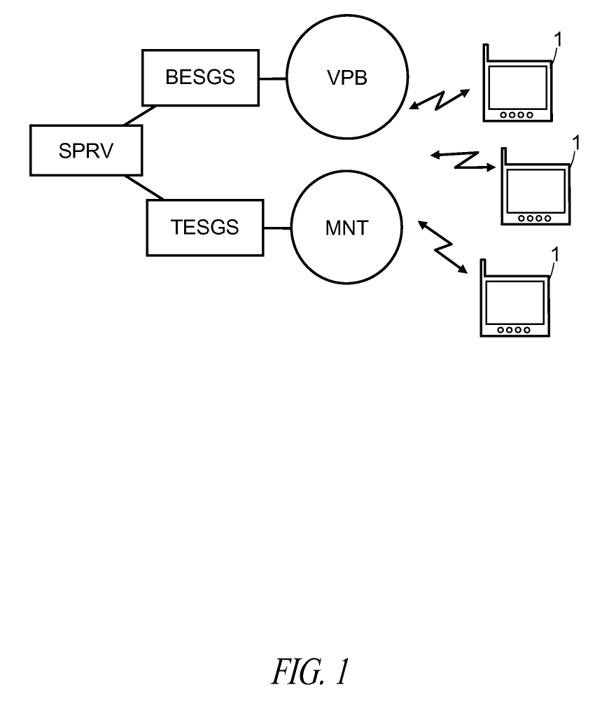

FIG. 1 shows a system for broadcasting video programs VPB comprising a system for broadcasting program guides relating to the video programs broadcasted by the system VPB and mobile terminals 1 adapted to the reception of video programs and the program guides broadcasted. The program guides are generated by a program guide server BESGS, the information contained in the program guide being supplied to the server BESGS by a program server SPRV. The programs broadcasted by the broadcast system VPB comply for example with the DVB-H standard.

Advantageously, the terminals also comprise means for connecting to a mobile network MNT which may be used to supply additional information, linked or not to the video programs broadcasted, for example as part of interactive services. The additional information may be supplied by the server SPRV to another program guide server TESGS connected to the mobile network MNT.

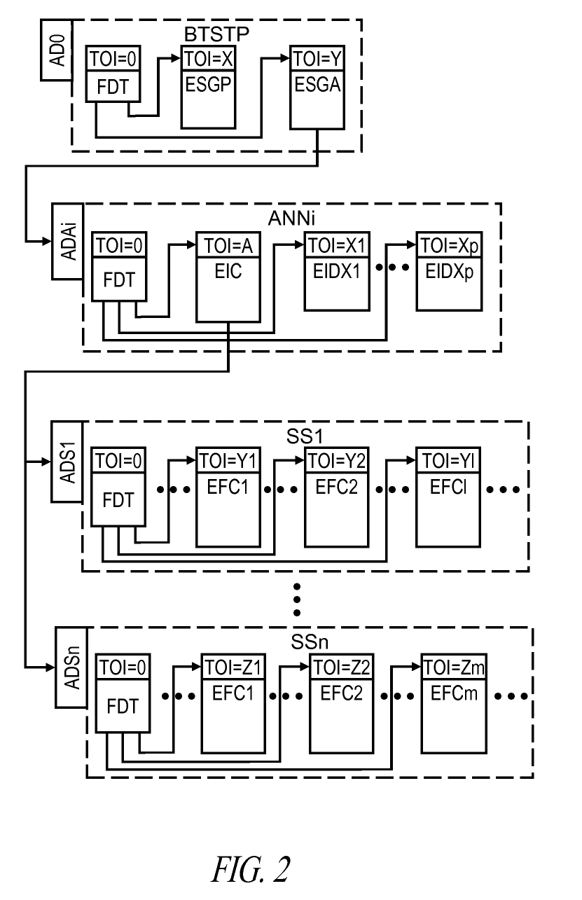

FIG. 2 shows in block form the structure of the information transmitted by the program guide service, in accordance with the FLUTE protocol (File deLivery over Unidirectional Transport) by the server BESGS. Thus, the information comprises a starting data flow BTSTP of the program guide service, also called “Bootstrap session”, acquisition data flows of program guides ANNi, also called “Announcement sessions”, and structured data flows SS1, . . . SSn, also called “ESG sessions”. The structured data, also called “metadata”, allow in particular information to be searched, a hard disc to be programmed, and a video program schedule to be displayed on the screens of the terminals 1 (See FIG. 1).

The flow BTSTP indicates which program guides are available and how to obtain them. Several operators may thus have their own program guides adapted to each type of terminal. The flow BTSTP is available at an IP address AD0 known by user terminals. It comprises several sets of data, each indicated by an identifier TOI (Transport Object Identifier), including a table FDT (File Delivery Table) associated to an identifier TOI equal to 0 and describing the content of the other sets of data of the flow BTSTP, i.e. the identifier X, Y of each of the other sets of data contained in the flow, and the structure of the content of each set. Thus, in the example of FIG. 1, the flow BTSTP comprises two sets of data, i.e. a set ESGP comprising information on service guide suppliers, and a set of access data ESGA comprising in particular the IP addresses ADAi of the data flows ANNi allowing the program guides of each operator referenced in the set ESGP to be accessed.

Each data flow ANNi supplies the information making it possible to access a program guide of an operator for a given platform, i.e. a particular type of mobile terminal. Each data flow ANNi describes how the information of the program guide is distributed among one or more display data flows SS1, . . . SSn, and how to access those flows. Like the flow BTSTP, each flow ANNi comprises several data sets associated to an identifier TOI, including a table FDT indicated by the identifier 0, giving the identifier and describing the content of each of the other data sets of the flow. Each flow ANNi thus comprises a set EIC indicated by the identifier A defining the transmission format of the corresponding program guide, and in particular if the program guide is transmitted in the form of one or more display data flow(s) SS1-SSn. The set EIC also comprises the IP addresses ADS1, . . . ADSn of the display data flows. The set EIC also comprises a list of indexes and a structure of indexes allowing the terminals to detect a change in a part called “fragment” in a display data flow without having to receive all the fragments of the flow again. The structure of indexes allows sets of sub-indexes EIDX1, . . . EIDXP indicated in the table FDT by identifiers X1, . . . Xp to be defined.

Each metadata flow of program guide SS1-SSn comprises several data sets, each associated to an identifier TOI, including a table FDT indicated by the identifier 0, giving the identifier and describing the content of the other data sets, called “fragments” EFC1, . . . EFCm, of the flow SS1-SSn.

The information contained in the flows BTSTP, ANNi, . . . , SS1-SSn is broadcasted in loop or in carousel mode during repetitive cycles. Thus, all the information of a flow may be obtained by accessing the IP address of the flow, and by listening the data flow broadcasted during a broadcast cycle. The information of a program guide may be distributed among the display data flows SS1-SSn according to the frequency at which it must be repeated, each flow having its own cycle duration. In a flow, some information may be repeated to be broadcasted at a higher frequency than that of the flow.

To guarantee the management of program guide update, each set of information of a flow is associated to a version number and to an expiration date which are defined in the table FDT of the flow.

Updating a flow ANNi, SS1-SSn may alternately be determined from the information contained in the table in relation to the table FDT of the flow previously received. For example, an update may be indicated in the table FDT of the flow by an identifier TOI modified in relation to the table FDT of the flow previously received.

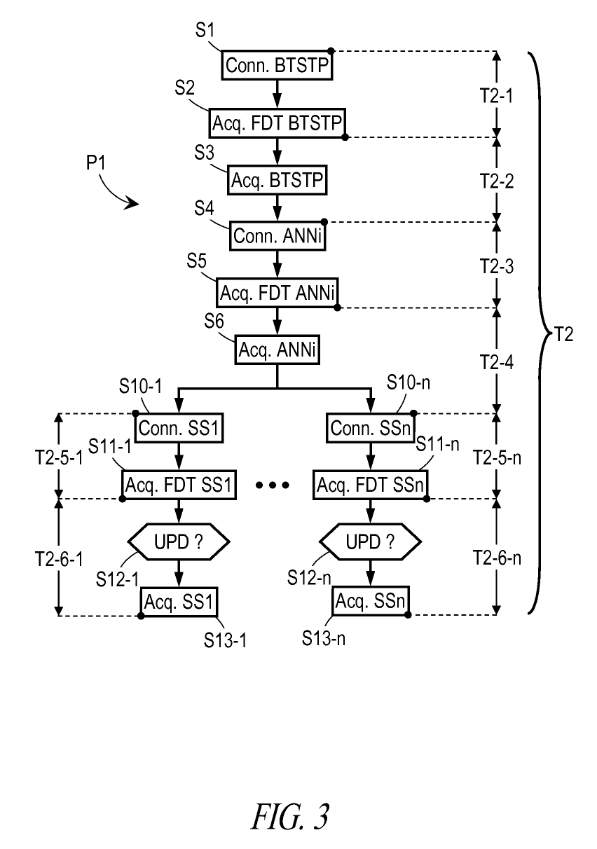

To update a program guide in its memory, a terminal 1 executes the procedure P1 shown in FIG. 3. Given the structure of the information of the program guides previously described (FIG. 2), the procedure P1 comprises successive initialization steps S1 to S6 and steps of acquisition of the information of the program guide S10-j to S13-j, where j is an integer between 1 and n, n is the number of display information flows SS1-SSn in which the information of the program guide is distributed.

At step S1, the terminal 1 connects to the flow BTSTP using an IP address which is stored in its memory or available by any means, for example input by the terminal user, received by the terminal in the form of a SMS (Short Message Service), . . . . At step S2, the terminal 1 receives the table FDT defining the structure of the data of the flow BTSTP. At step S3, the terminal 1 receives the data of the flow BTSTP and selects among the data received the IP address of the program guide desired.

Then, the terminal 1 connects to the selected IP address (step S4), and receives the table FDT of the acquisition flow ANNi located at the selected IP address (step S5). At step S6, the terminal receives the data of the flow ANNi comprising the IP addresses of the display data flows SS1-SSn.

The steps of acquisition of display data flows SS1-SSn may then be executed in parallel by the terminal 1, since these flows are available at different IP addresses. Thus, for each flow SSj (SS1-SSn), the terminal executes a step S10-j (S10-1, . . . S10-n) of connecting to the address for broadcasting the display data flow SSj, collected in the flow ANNi, and a step S11-j of receiving the table FDT of the flow SSj. If the table FDT received indicates that an update has been performed in relation to the corresponding data memorized by the terminal (step S12-j), the terminal executes the step S13-j of receiving the display data contained in the flow SSj which has been updated.

Given the procedure P1 previously described, the maximum duration of the period T2 indicated in FIG. 3 results from the accumulated total of the following durations:
the maximum acquisition duration T2-1 of the table FDT of the flow BSTTP,
the maximum acquisition duration T2-2 of the content of the flow BSTTP,
the maximum acquisition duration T2-3 of the table FDT of the flow ANNi,
the maximum acquisition duration T2-4 of the content of the flow ANNi,
the maximum acquisition duration T2-5-j of the table FDT of the flow SSj, and
the maximum acquisition duration T2-6-j of the content of the flow SSj.

If no update is to be performed by the terminal 1, the maximum duration of the period T2 may be calculated as follows:

T2=T2-1+T2-2+T2-3+T2-4+MAXⱼ(T2-5j) (1)

where MAXⱼ(T2-5j) represents the longest duration among the durations T2-5-j for all the flows SSj.

If a complete update is performed, the maximum duration of the period T2 is calculated as follows:

T2=T2-1+T2-2+T2-3+T2-4+MAXⱼ(T2-5j+T2-6j) (2)

The acquisitions of the flows BTSTP, ANNi, SS1-SSn required for updating a program guide are necessarily performed sequentially, the acquisition of a flow ANNi requiring information supplied by the flow BTSTP, and the acquisition of the flows SS1-SSn requiring information supplied by the corresponding flow ANNi.

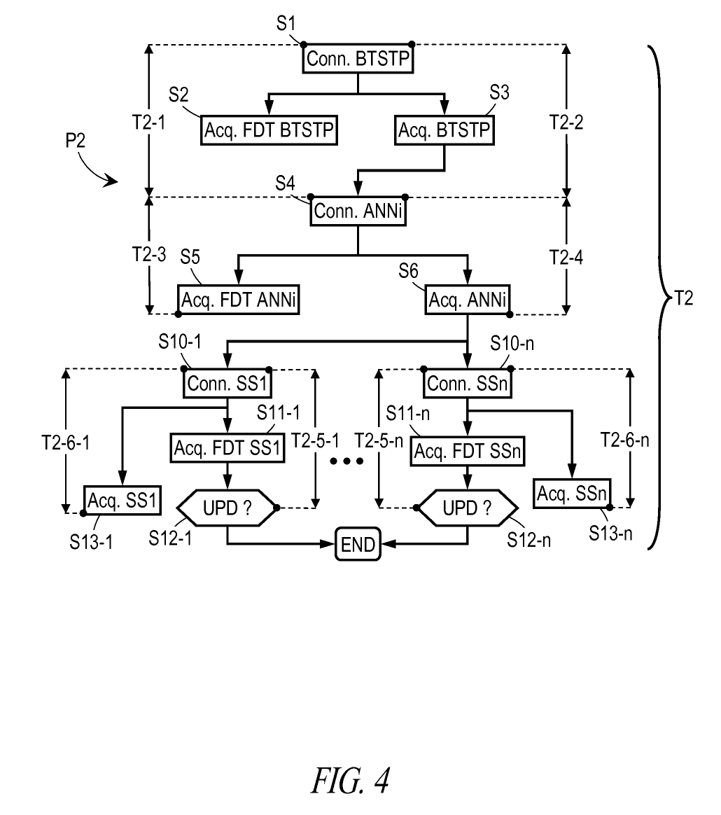

According to one embodiment of the invention shown in FIG. 4, the duration of the period T2 may be reduced by providing to render the flow acquisitions parallelizable. Thus, FIG. 4 shows an update procedure P2 comprising the same steps as the procedure P1. In the procedure P2, each terminal 1 performs receiving in parallel the table FDT of a flow and the data of the flow. This mode of reception in parallel may be applied to all the flows BTSTP, ANNi, SS1-SSn or only a part of these flows.

In the procedure P2, steps S2 and S3 of loading the table and the data of the flow BTSTP are executed in parallel. It is the same for steps S5 and S6 for the flow ANNi and steps S1′-j and S3-j for each flow SSj (SS1-SSn). As the update information of each flow SS1-SSn is only available once the corresponding table FDT is loaded by the terminal, the terminal may stop loading the data at a step S13-j if it appears at step S12-j that the data have not been updated.

Thus, in the embodiment shown in FIG. 4, when the information of the selected program guide has not been updated, the maximum duration of the period T2 becomes:

T2=MAX(T2-1,T2-2)+MAX(T2-3,T2-4)+MAXⱼ(T2-5j) (3)

In the event of an update, the maximum duration of the period T2 may be evaluated as follows:

T2=MAX(T2-1,T2-2)+MAX(T2-3,T2-4)+MAXⱼ(T2-5j,T2-6j) (4)

The maximum duration of the period T2 remains unchanged if the duration of acquisition T2-6-j of each of the flows received is lower than the maximum duration MAXⱼ(T2-5j), taking into account all the flows SS1-SSn.

According to another embodiment of the invention, the information of modification of the program guide information is added by the server BESGS in the first data flow acquired, i.e. the flow BTSTP shown in FIG. 2. Thus, a version number is added for each program guide, i.e. for each flow ANNi referenced in the flow BTSTP. The version numbers are preferably added in the table FDT of the flow BTSTP.

Admittedly, other means for indicating the update of a version number may be used, like the use of new identifiers TOI to reference updated information.

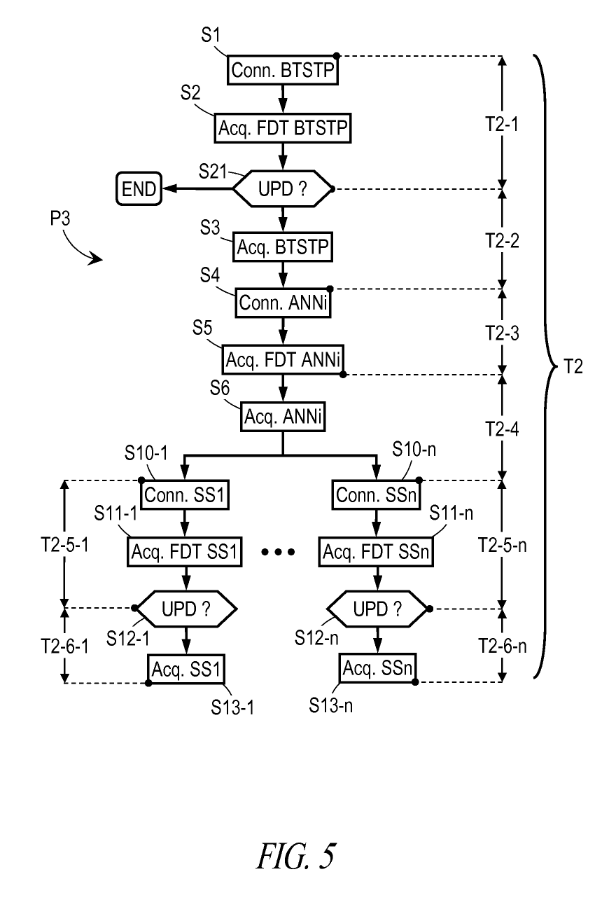

The procedure for updating the program guide memorized by a terminal 1 may thus be modified as shown in FIG. 5. FIG. 5 shows a procedure P3 comprising the same steps as the steps of procedure P1. The procedure P3 also comprises an additional step S21 inserted between steps S2 and S3. Step S21 determines according to the version number read for the program guide to be updated, if new information is received for this program guide. If no update is received, procedure P3 ends without performing receiving the other data flows. If the program guide has been updated, the update tests performed at steps S12-1, . . . S12-n allow the flows SS1-SSn which have been updated to be determined.

Thus, if the program guide requested by the terminal 1 is not updated, the maximum duration of the period T2 is equal to the duration for downloading the table FDT of the flow BTSTP:

T2=T2-1 (5)

In the event of an update of the program guide requested, this change of the table FDT of the flow BTSTP has practically no effect on the maximum duration of period T2, only version numbers being transmitted in addition to the information usually transmitted.

The version number chosen may be the date in seconds since a predefined reference date. If no version number is present in the flow BTSTP, or if a version number greater than that memorized by the terminal is present in the flow BTSTP, or if the terminal does not memorize any version number, the procedure P3 goes on until loading the display data flows SS1-SSn. If on the contrary, the version number present in the flow BTSTP is identical to that memorized by the terminal, the procedure P3 is stopped.

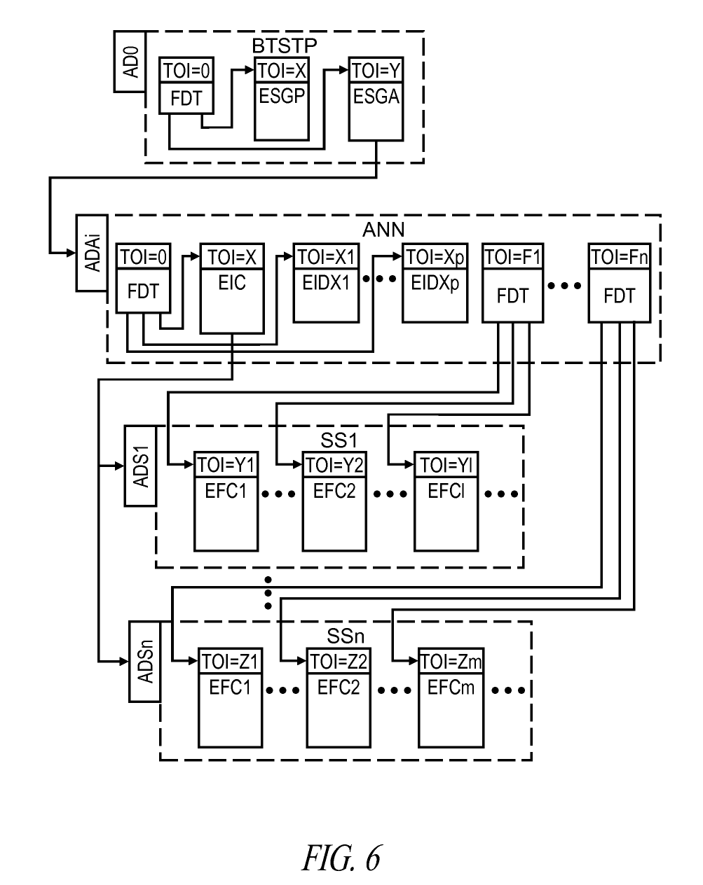

According to another embodiment of the invention, it is desired to avoid the terminals 1 trying to access all the flows SS1-SSn, but only the updated flows. To that end, the tables FDT are removed from the flows SS1-SSn and inserted into the information flow ANNi by the server BESGS, as shown in FIG. 6. In FIG. 6, the tables FDT of the flows SS1-SSn are transmitted in the flow ANNi, each of these tables being associated to an identifier TOI F1-Fn. The flows SS1-SSn therefore do not comprise any table FDT.

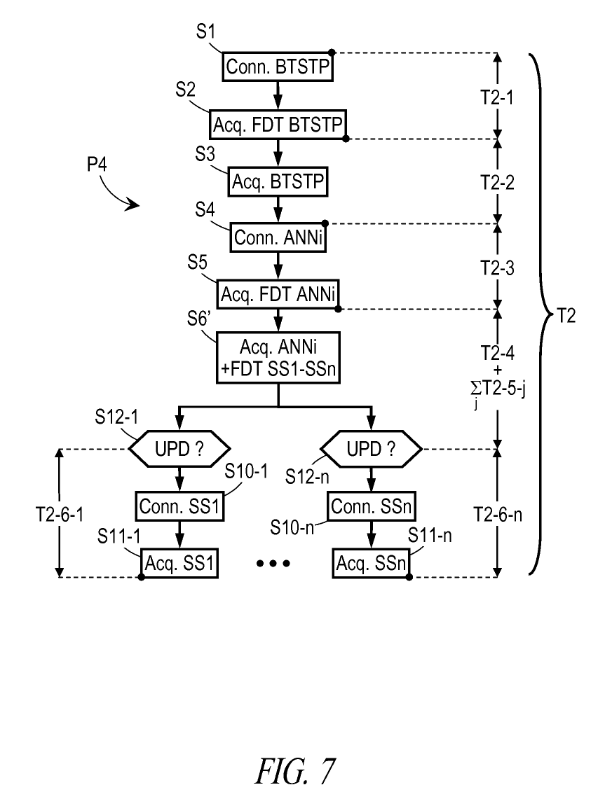

The update procedure may therefore be modified as shown in FIG. 7. FIG. 7 shows an update procedure P4 comprising the same steps as procedure P1, except for step S6 which is replaced by a step S6′ of receiving the flow ANNi modified to include the tables FDT of the flows SS1-SSn. In relation to procedure P1, the update test steps S12-1, . . . S12-n of procedure P4 are performed before steps S10-1, . . . S10-n of accessing the terminal at the addresses ADS1-ADSn for broadcasting the display data flows SS1-SSn.

Thus, as soon as the flow ANNi of a desired program guide is received, the terminal 1 may determine using the tables FDT of the flows SS1-SSn received in the flow ANNi if at least one flow SS1-SSn of the program guide has been updated. The duration of execution of step S6′ is equal to the duration T2-4 increased by the sum of the durations T2-5-j for downloading the tables FDT of the flows SS1-SSn. The maximum duration of period T2 is therefore the following:

T2=T2-1+T2-2+T2-3+T2-4+ΣT2-5j (6)

if a program guide is not updated, and if the flow SSj is updated:

T2=T2-1+T2-2+T2-3+T2-4+ΣT2-5j+T2-6j (7)

The tables FDT of the flows SS1-SSn have a size around some dozens of bytes. The increase of the duration of step S6′ in relation to that of step S6 therefore does not significantly penalize the duration of period T2, in the event of an update of the program guide or not.

It is to be noted that the presence of updates of the flows SS1-SSn may be indicated in the flow ANNi by providing in the flow ANNi a simple version number for each flow SS1-SSn.

Advantageously, two embodiments previously described or all of them may be combined. FIG. 8 shows a procedure P5 for updating a program guide, when these three embodiments are combined according to another embodiment of the invention. In FIG. 8, the tables FDT and the data of each flow BTSTP, ANNi are received in parallel; step S2 is followed by step S21 of testing the update of the selected program guide; the tables FDT of the flows SS1-SSn are received in the flow ANNi (step S6′); and only the flows SS1-SSn updated are received.

Thanks to these measures, the maximum duration of period T2 is equal to T2-1 if a program guide is not updated, and:

T2=MAX(T2-1,T2-2)+MAX(T2-3,T2-4+ΣT2-5j)+T2-6j (8)

only if the flow SSj is updated.

If there is no update, the maximum duration of period T2 may therefore be reduced thanks to the invention, to pass from several dozens of minutes to several seconds.

Knowing that the cases of not updating the program guides are the most usual, each terminal 1 may quickly check for a very low cost in energy if an update is available. The duration of period T1, currently around 24 hours, which defines the smallest update period possible may therefore be reduced to allow more frequent updates of the program guides displayed by the terminals 1 to be performed.

An intermediate solution may be considered in between procedure P2 on the one hand and procedures P4 and P5 on the other hand. This intermediate solution consists in introducing in the flow ANNi only version numbers of the flows SS1-SSn, which makes it possible to keep steps S12-1, . . . S12-n before steps S10-1, . . . S10-n without penalizing the duration T2-4 of the step of loading the flow ANNi (step S6 of procedure P2 instead of step S6′ of procedures P4 and P5) and to keep the advantage of loading in parallel tables FDT (steps S12-1, . . . S12-n) and data (steps S13-1, . . . S13-n) of the flows SS1-SSn of procedure P2.

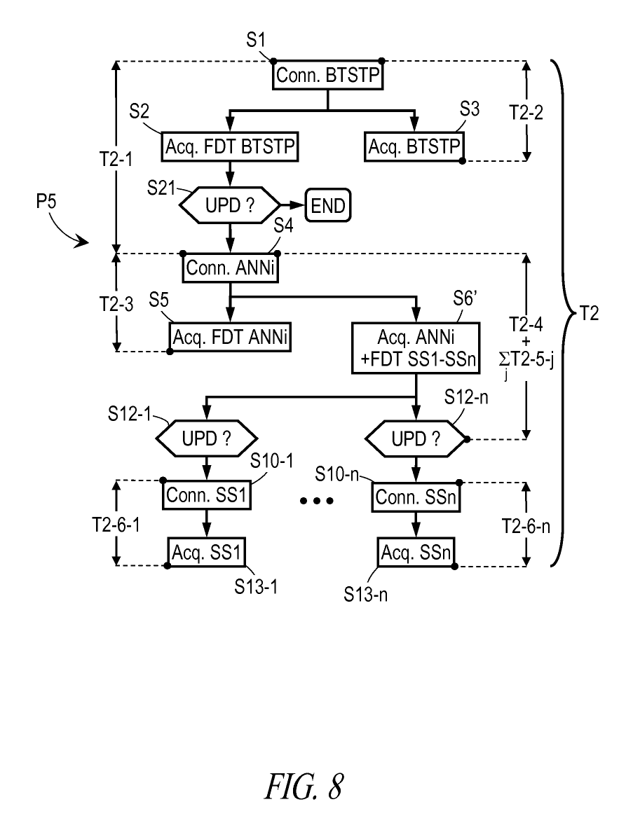

FIG. 9 shows an information structure of program guides according to another embodiment of the invention. In FIG. 9, the structure of the information transmitted by the program guide service comprises two starting data flows of the program guide service BTSTP1, BTSTP2, two acquisition data flows ANN1i, ANN2i by program guide i, and two sets of display data flows SS11, . . . SS1n, SS21, . . . SS2n for each program guide.

The data flows BTSTP1 and BTSTP2 are available at IP addresses known by the terminals 1. The flow BTSTP1 comprises the table FDT (File Delivery Table) indicated by an identifier TOI equal to 0 and describing the content of the flow BTSTP2, i.e. the identifier X, Y of each set of data contained in the flow BTSPT2, and the structure of the content of each of these sets. Thus, in the example of FIG. 9, the flow BTSTP2 comprises two sets of data, i.e. a set ESGP comprising information on operators suppliers of service guide, and a set of access data ESGA comprising in particular the IP addresses ADA1i, ADA2i of the data flows ANN1i, ANN2i allowing the program guides of each operator referenced in the set ESGP to be accessed.

Each data flow ANN2i supplies the information making it possible to access a program guide of an operator for a given platform, i.e. a particular type of mobile terminal. Each data flow ANN1i comprises a table FDT indicated by the identifier 0, giving the identifier and describing the content of the flow ANN2i. Each flow ANN2i describes how the information of the program guide is distributed among several flows SS1, . . . SSn, and how to access the information relating to the flows SS1-SSn. The flow ANN2i comprises a set EIC indicated by the identifier X defining the transmission format of the corresponding program guide, and in particular if the program guide is transmitted in the form of several flows. If this is the case, the set EIC also comprises the IP addresses ADS11, . . . ADS1n, ADS21, . . . ADS2n of the display data flows SS11-SS1n, SS21-SS2n. The set EIC also comprises a list of indexes and a structure of indexes allowing the terminals to detect a change in a part called “fragment” in a program guide without having to receive all the fragments of a flow SS1-SSn again. The structure of indexes allows sets of sub-indexes EIDX1, . . . EIDXP indicated in the table FDT by identifiers X1, . . . Xp to be defined.

Each flow SS11-SS1n comprises a table FDT indicated by the identifier 0, giving the identifier and describing the content of the corresponding flow SS21-SS2n. Each flow SS21-SS2n contains several fragments of data EFC1, . . . EFCm, each associated to an identifier TOI.

The information structure shown in FIG. 9 complies with the update procedure P2 shown in FIG. 4. It may be modified so that the tables FDT of the flows SS11-SS1n appear in the flow ANN2i. With such an information structure, the terminals 1 execute the update procedure P5 shown in FIG. 8.

In this intermediate solution, the maximum duration of the period T2 if there is not update, corresponds to that of the procedure shown in FIG. 7 or 8, and if there is an update, to that of the procedure shown in FIG. 4.

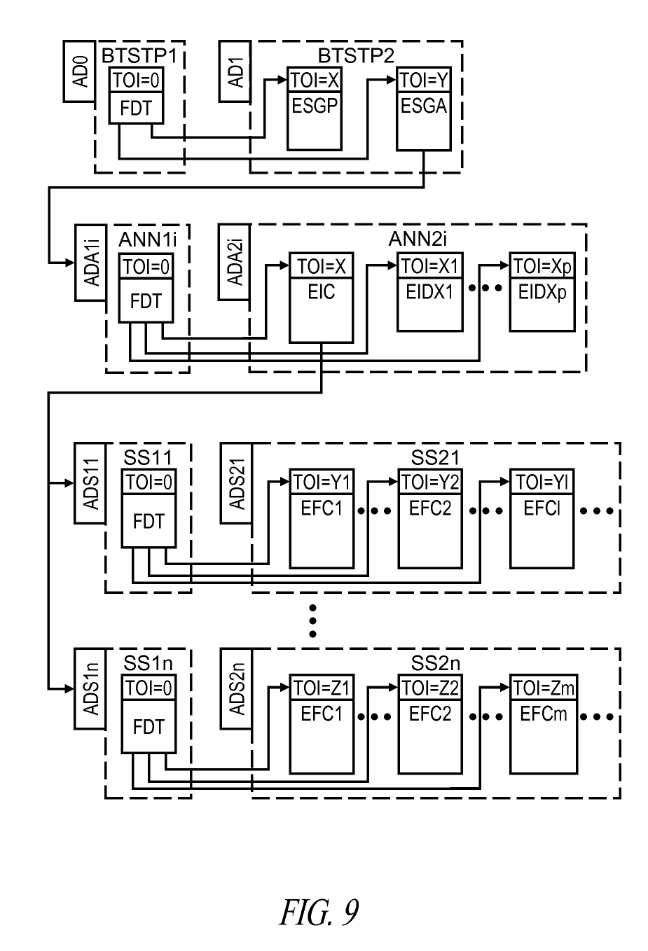

FIG. 10 is a functional block diagram of an embodiment of a device 1000, such as a terminal or mobile telephone device, configured to receive information broadcast in a repetitive loop. The device 1000 comprises at least one memory 1002 and at least one processor 1004. The device 1000 comprises at least one interface 1006 configured to receive data flows and a data flow control module 1008 configured to process the received data flows. As illustrated, the device 1000 has two interfaces 1006. The data flow control module 1008 may be configured to process received data flows broadcast in repetitive loops, such as embodiments of the data flows described herein with respect to FIGS. 6 and 9, in accordance with embodiments of the methods described herein, such as the methods described with respect to FIGS. 4, 5, 7 and 8. The at least one memory 1002 may be configured to store the memorized information of the data flows. In an embodiment, the at least one memory 1002 may be configured to store instructions for causing the at least one processor 1004 to execute instructions to perform the functions of the data flow control module 1008. In some embodiments the device 1000 may comprise discrete circuitry 1010 in addition to or instead of the illustrated memory 1002, processor 1004 and data flow control module 1008.

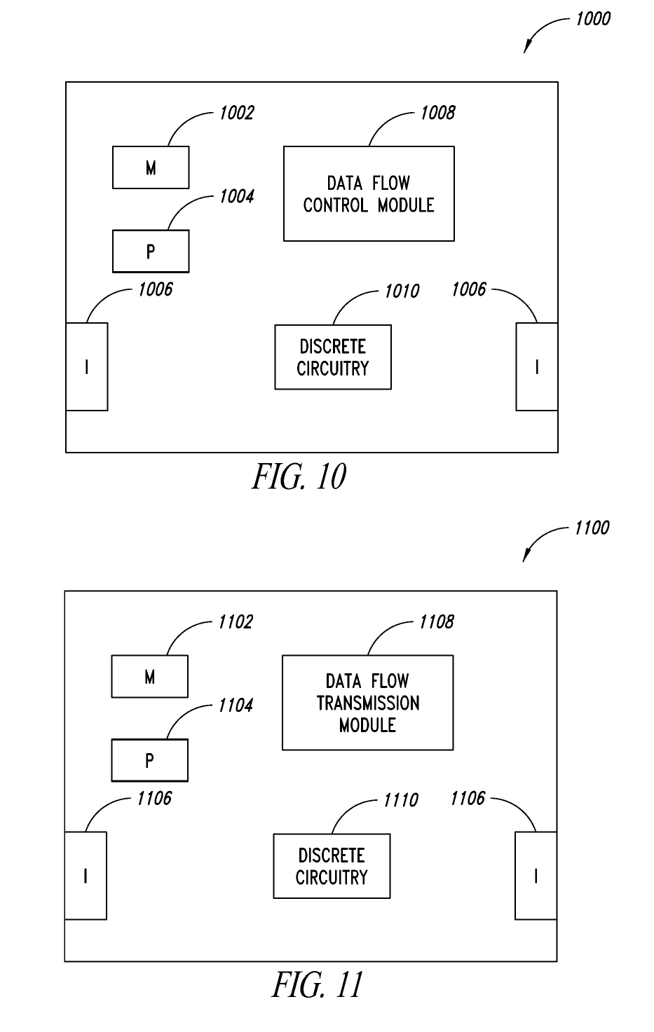

FIG. 11 is a functional block diagram of an embodiment of a transmission system 1100, such as a system for broadcasting video programs, configured to broadcast information in a repetitive loop. The system 1100 comprises at least one memory 1102 and at least one processor 1104. The system 1100 comprises at least one interface 1106 configured to transmit signals from a data flow transmission module 1108 configured to control the transmission of data flows. As illustrated, the transmission system 1100 has two interfaces 1106. The data flow transmission module 1108 may be configured to generate control signals to cause the transmission of data flows in repetitive loops, such as embodiments of the data flows described herein with respect to FIGS. 6 and 9, in accordance with embodiments of the methods described herein, such as the methods described with respect to FIGS. 4, 5, 7 and 8. The at least one memory 1102 may be configured to store the data flows to be transmitted. In some embodiments, the system 1100 may cause other devices (see BESGS and TESGS shown in FIG. 1) to transmit the data flows. In an embodiment, the at least one memory 1102 may be configured to store instructions for causing the at least one processor 1104 to execute instructions to perform the functions of the data flow transmission module 1108. In some embodiments the system 1100 may comprise discrete circuitry 1110 in addition to or instead of the illustrated memory 1102, processor 1104 and data flow transmission module 1108.

It will be clear to those skilled in the art that the present disclosure is susceptible of various other embodiments and applications. In particular, the disclosure is not limited to a three-level information structure like that shown in FIG. 2 comprising a first level comprising the flow BTSTP, a second level comprising the flows ANNi for each program guide, and a third level comprising all the sets of flows SS1-SSn of each program guide. Indeed, it is easy to imagine a two-level structure or a structure with more than three levels to be adapted to a particular application.

Although it makes it possible to resolve a problem linked to the fact that mobile terminals do not have an unlimited power source, the disclosure does not only apply to mobile terminals, but to any terminal susceptible of receiving information broadcasted in loop and susceptible of containing update information.

The disclosure does not only apply to the update of program guides as part of a system for broadcasting video programs to mobile terminals. It more generally applies to the update of structured information memorized by terminals using information flows broadcasted in loop.

The detailed description has set forth various embodiments of the devices and/or processes via the use of block diagrams and examples. Insofar as such block diagrams and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape. Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for receiving structured data to be memorized by a terminal, the structured data being periodically broadcast in a form of structured data flows, the method comprising:
receiving a starting data flow available at an address known by the terminal and comprising information for accessing at least one set of at least one structured data flow;
selecting a set of structured data flows to be memorized by the terminal;
selectively receiving each structured data flow of the selected set, available using the access information supplied in the starting flow; and
selectively updating the data memorized by the terminal if the structured data received have been updated in relation to structured data memorized by the terminal,
wherein each set of structured data flows is associated in the starting data flow to an update piece of information making it possible to deduce if data of the set of structured data flows have been updated, the step of receiving a starting data flow comprising determining if the selected set of structured data flows has been updated, according to the associated update piece of information, comprised in the starting flow, the steps of selectively receiving and selectively updating being executed only if the selected set of structured data flows has been updated.

2. The method of claim 1 wherein the piece of information for updating a set of structured data flows in the starting flow comprises a version number, the method comprising comparing the version number of the selected set of structured data flows, received in the starting flow, to a version number memorized by the terminal, and updating the version number memorized by the terminal with the version number received.

3. The method of claim 1 wherein the information for accessing at least one set of structured data flows to be memorized by the terminal comprises at least an address for accessing an acquisition data flow, the acquisition data flow comprising the address of each structured data flow of the set of structured data flows to be memorized by the terminal, the method comprising receiving an acquisition data flow at a selected access address, supplied in the starting data flow, and accessing each structured data flow to be memorized by the terminal, using each address supplied in the acquisition flow.

4. The method of claim 3 wherein each structured data flow is associated to an update piece of information comprised in a corresponding acquisition data flow making it possible to deduce if the structured data flow has been updated, the steps of selectively receiving and of selectively updating being executed for a structured data flow only if the structured data flow has been updated.

5. The method of claim 4 wherein the piece of information for updating a structured data flow comprised in the acquisition flow is a version number, the method comprising comparing the version number of each structured data flow of the selected set, to a version number of the structured data flow memorized by the terminal, and updating the version number of the structured data flow memorized by the terminal with the version number received.

6. The method of claim 4 wherein each structured data flow is associated to a table describing the structure of the data in the flow and comprising the update piece of information making it possible to deduce if the structured data flow has been updated, each table of structured data flow being inserted into the corresponding acquisition data flow.

7. The method of claim 1 wherein at least one of the data flows comprises a table describing the structure of the flow, receiving the flow being performed by receiving in parallel the table and the data of the flow.

8. The method of claim 1 wherein at least one of the data flows is divided into two data flows available at different addresses, comprising a first flow comprising a table describing a structure of data, and a second flow comprising data which structure is described in the table of the first flow, the first flow and the second flow being received in parallel by the terminal.

9. The method of claim 1 wherein several structured data flows are received in parallel by the terminal.

10. The method according of claim 1, comprising displaying by the terminal structured data updated with the structured data received.

11. The method of claim 1 wherein the structured data are data for displaying program guides sent to a system for broadcasting video programs according to the DVB-H standard.

12. A terminal for receiving structured information to be memorized, the structured information being periodically broadcasted in the form of structured data flows, the terminal being configured to execute the following steps:
receiving a starting data flow available at an address known by the terminal and comprising information for accessing at least one set of at least one structured data flow;
selecting a set of structured data flow to be memorized by the terminal;
selectively receiving each structured data flow of the selected set, available using the access information supplied in the starting flow; and
selectively updating the data memorized by the terminal if the structured data received have been updated in relation to structured data memorized by the terminal,
wherein each set of structured data flows is associated in the starting data flow to an update piece of information making it possible to deduce if data of the set of structured data flows have been updated, the terminal being configured to determine if the selected set has been updated according to the associated update piece of information, received in the starting flow, and to execute the selectively receiving and updating steps only if the selected set of structured data flows has been updated.

13. The terminal of claim 12 wherein the piece of information in the starting flow comprises a version number, the terminal being configured to compare the version number of the selected set of structured data flows, received in the starting flow, to a memorized version number, and to update the version number memorized with the version number received.

14. The terminal of claim 12 wherein the information for accessing at least one set of structured data flows to be memorized by the terminal comprises at least one address for accessing an acquisition data flow, the acquisition data flow comprising the address of each structured data flow of the set of structured data flows to be memorized by the terminal, the terminal being configured to receive an acquisition data flow at a selected access address, supplied in the starting data flow, and to access each structured data flow to be memorized, using each address supplied in the acquisition flow.

15. The terminal of claim 14 wherein each structured data flow is associated to an update piece of information comprised in the corresponding acquisition flow making it possible to deduce if the structured data flow has been updated, the terminal being configured to execute the receiving and updating steps for a structured data flow only if the structured data flow has been updated.

16. The terminal of claim 15 wherein the piece of information for updating a structured data flow comprised in the acquisition flow is a version number, the terminal being configured to compare the version number of each structured data flow of the selected set, to a version number of the structured data flow memorized by the terminal, and to update the version number of the structured data flow memorized by the terminal with the version number received.

17. The terminal of claim 15 wherein each structured data flow is associated to a table describing the structure of the data comprised in the flow and comprising the update piece of information making it possible to deduce if the structured data flow has been updated, each table of structured data flow being inserted into the corresponding acquisition data flow.

18. The terminal of claim 12 wherein at least one of the data flows comprises a table describing the structure of the flow, the terminal being configured to receive in parallel the table and the data of the flow.

19. The terminal of claim 12 wherein at least one of the data flows is divided into two data flows available at different addresses, comprising a first flow comprising a table describing a structure of data, and a second flow comprising data which structure is described in the table of the first flow, the terminal being configured to receive the first flow and the second flow in parallel.

20. The terminal of claim 12, configured to receive several structured data flows in parallel.

21. The terminal of claim 12, configured to display the structured data updated with the structured data received.

22. The terminal of claim 12 wherein the structured data flows comprise data for displaying program guides transmitted to a system for broadcasting video programs according to the DVB-H standard.

23. The terminal of claim 12, comprising a mobile telephony device.

24. A method for emitting structured data to be memorized by terminals, the structured data being periodically broadcasted in the form of structured data flows, the method comprising:
emitting a starting data flow available at an address known by terminals and comprising information for accessing at least one set of at least one structured data flow; and
emitting each structured data flow of each set of structured data flows,
wherein each set of structured data flows is associated in the starting data flow to an update piece of information making it possible to deduce if data of the set of structured data flows have been updated.

25. The method of claim 24 wherein the information for updating a set of structured data flows comprised in the starting flow comprises a version number.

26. The method of claim 24 wherein the information for accessing at least one set of structured data flows to be memorized by the terminals comprises at least one address for accessing an acquisition data flow, the acquisition data flow comprising the address of each structured data flow of a set of structured data flows, the method comprising emitting at least one acquisition data flow at an access address comprised in the starting data flow.

27. The method of claim 26 wherein each structured data flow is associated to an update piece of information comprised in the corresponding acquisition flow making it possible to deduce if the structured data flow has been updated.

28. The method of claim 27 wherein the piece of information for updating a structured data flow comprised in the acquisition flow is a version number.

29. The method of claim 27 wherein each structured data flow is associated to a table describing the structure of the data comprised in the flow and comprising the update piece of information making it possible to deduce if the structured data flow has been updated, each table of structured data flows being inserted into the corresponding acquisition data flow.

30. The method of claim 24 wherein at least one of the data flows is divided into a first flow comprising a table describing a structure of data, and a second flow comprising data which structure is described in the table of the first flow, the first flow and the second flow being emitted in parallel at different addresses.

31. The method of claim 24 wherein several structured data flows are emitted in parallel at different addresses.

32. The method of claim 24 wherein the structured data are data for displaying program guides transmitted to a system for broadcasting video programs according to the DVB-H standard.

33. A transmitter of structured information to be memorized by terminals, the structured data being periodically broadcasted in the form of structured data flows, the transmitter being configured to execute the following steps:
emitting a starting data flow available at an address known by the terminals and comprising information for accessing at least one set of at least one structured data flow; and
emitting each structured data flow of each set of structured data,
wherein each set of structured data flows is associated in the starting data flow to an update piece of information making it possible to deduce if data of the set of structured data flows have been updated.

34. The transmitter of claim 33 wherein the piece of information for updating a set of structured data flows comprised in the starting flow comprises a version number.

35. The transmitter of claim 33 wherein the information for accessing at least one set of structured data flows to be memorized by the terminals comprises at least one address for accessing an acquisition data flow, the acquisition data flow comprising the address of each structured data flow of the set of structured data flows, the transmitter being configured to emit at least one acquisition data flow at an access address supplied in the starting data flow.

36. The transmitter of claim 35 wherein each structured data flow is associated to an update piece of information comprised in the corresponding acquisition flow making it possible to deduce if the structured data flow has been updated.

37. The transmitter of claim 36 wherein the piece of information for updating a structured data flow comprised in the acquisition flow is a version number.

38. The transmitter of claim 36 wherein each structured data flow is associated to a table describing the structure of the data comprised in the flow and comprising the update piece of information making it possible to deduce if the structured data flow has been updated, each table of structured data flow being inserted into the corresponding acquisition data flow.

39. The transmitter of claim 33 wherein at least one of the data flows is divided into a first flow comprising a table describing a structure of data, and a second flow comprising data which structure is described in the table of the first flow, the transmitter being configured to emit in parallel the first flow and the second flow at different addresses.

40. The transmitter of claim 33 wherein the structured data are data for displaying program guides transmitted to a system for broadcasting video programs according to the DVB-H standard.
